(19) United States
(12) Patent Application Publication
(10) Pub. No.: US 2025/0052282 A1
(43) Pub. Date: Feb. 13, 2025

(54) CARDAN SHAFT SLIDING ASSEMBLY

(71) Applicant: TIRSAN KARDAN SANAYI VE TICARET ANONIM SIRKETI, Yunusemre, Manisa (TR)

(72) Inventor: Hüseyin ÖZGÜRLER, Yunusemre, Manisa (TR)

(21) Appl. No.: 18/719,009

(22) PCT Filed: Nov. 21, 2022
(86) PCT No.: PCT/TR2022/051324

§ 371 Date: Jun. 12, 2024

(30) Foreign Application Priority Data
Dec. 23, 2021 (TR) 2021/020858

(51) Int. Cl. F16D 3/06; F16D 3/38; F16D 3/84

(52) U.S. Cl. CPC F16D 3/06; F16D 3/382; F16D 3/848

(57) ABSTRACT

Disclosed is a cardan shaft sliding assembly suitable for both a gearbox-differential arrangement, which provides the cardan shaft freedom of motion in the axial direction, and for an undercarriage arrangement between two axles. The cardan shaft sliding assembly has multiple mounting diameters of different dimensions positioned on a yoke shaft in order to provide housing and assembly of the protective cover in both the gearbox-differential arrangement and the undercarriage arrangement between two axles. The yoke shaft with the mounting diameters provides the cardan shaft with freedom of motion in the axial direction and is one of the parts forming the sliding assembly.

### TECHNICAL FIELD

The invention relates to a rear cardan shaft sliding assembly consisting of a yoke shaft, a tube sleeve, a protective cover, a protective cover seal, and a short cardan shaft sliding assembly between two axles consisting of a yoke shaft, a slip yoke, a protective cover, a protective cover seal, an oil cap and a plug, respectively, providing the cardan shaft with freedom of motion in the axial direction.

In particular, the invention relates to the rear cardan shaft sliding assembly between the gearbox and differential, and the short cardan shaft sliding assembly between the two axles, where instead of two different yoke shafts, a single yoke shaft is used in common by providing different protective cover mounting diameters on the yoke shaft.

### PRIOR ART

Cardan shaft or also known as drive shaft; is the part that transmits the motion received from the output shaft of the transmission to the differential box. This part, providing the connection between the gearbox and the differential, transmits the torque of the transmission to the differential, and from there to the axle shafts and wheels.

The cardan shaft sliding assembly provides an axial sliding movement to suspend the change in the distance between the gearbox and differential or between the two axles, which occurs depending on the undercarriage arrangement and varies depending on the road conditions. The seal housing diameters of the protective covers used on the tube sleeve of the rear cardan shaft sliding assembly between the gearbox and differential and the slip yoke of the short cardan shaft sliding assembly between two axles are different. Due to this diameter difference, protective cover sizes are also used differently and due to the mounting diameter, two different yoke shafts can be produced under different product codes and used separately with these sliding shafts.

Today, many studies have been carried out and new embodiments have been developed in order to eliminate the existing disadvantages of cardan shaft sliding shafts. One of these studies is the invention subject to the patent application numbered TR2018/07402 and titled “A Yoke Shaft for Cardan shaft Embodiments”. The invention relates to the rotational movement and power of the engine in motor vehicles, a solid neck cone limiting the tube sleeve on the inclined body extending in a conical form by narrowing with a certain slope between the cover fastening diameter and the throttle part in order to make the neck section connecting the yoke section and the shaft section of the yoke shaft in the cardan shaft used in giving motion to the vehicle by transmitting it to the differential, and at least one sidewall retaining area on the said solid neck cone where the lower sidewall area of the tube sleeve is limited by contact.

Another study is the invention subject to patent application numbered TR2018/08372 and titled “Protective Structure for Sliding Assembly”. The invention relates to a vulcanized seal structure adhered to the protective cover inside the sliding assemblies in cardan shafts. In particular, the invention relates to the termination of the sliding assembly motion after it has moved in the direction of elongation during axial movement up to the permitted sliding length.

As a result, the need for a cardan shaft sliding assembly that eliminates the disadvantages of the existing technique and the inadequacy of existing solutions necessitated a development in the relevant technical field.

### BRIEF DESCRIPTION OF INVENTION

The present invention relates to a rear cardan shaft sliding assembly consisting of a yoke shaft, a tube sleeve, a protective cover, a protective cover seal, and a rear cardan shaft sliding assembly consisting of a yoke shaft, a slip yoke, a protective cover, a protective cover seal, an oil cap, and a plug, respectively, providing freedom of motion in the axial direction to the cardan shaft, which meets the above-mentioned requirements, eliminates all disadvantages, and provides some additional advantages.

Based on the prior art, the aim of the invention is to enable the formation of different protective cover mounting diameters on the yoke shaft by using a single yoke shaft in common instead of two different yoke shafts in the rear cardan shaft sliding assembly between the gearboxand differential and the short cardan shaft sliding assembly between the two axles.

The purpose of the invention is to improve the mounting diameter of the protective cover so that stresses under load can be reduced by around 9%.

Another purpose of the invention is to enable the cardan shaft sliding assembly to be used as a common part on two different platforms, thereby reducing inventory costs and increasing product performance by reducing stress distribution.

The structural and characteristic features and all the advantages of the invention will be more clearly understood with the following figures and the detailed description written with references to these figures, therefore, the evaluation should be made by considering these figures and detailed descriptions.

### BRIEF DESCRIPTION OF FIGURES

In order to best understand the embodiment of the present invention and its advantages with additional elements, it should be evaluated in accordance with the figures described below.

FIG. 1a is a schematic overview of the rear cardan shaft and sliding assembly between gearbox and differential,

FIG. 1b is a schematic overview of the cross-section of the rear cardan shaft sliding assembly between gearbox and differential,

FIG. 1c is a schematic overview of the disassembled rear cardan shaft sliding assembly between gearbox and differential,

FIG. 2a is a schematic overview of the short cardan shaft and sliding assembly between two axles,

FIG. 2b is a schematic overview of the cross-section of the short cardan shaft sliding assembly between two axles,

FIG. 2c is a general overview of the disassembled state of the short cardan shaft sliding assembly between two axles,

FIG. 3a is a schematic overview of the cross-section of the rear cardan shaft sliding assembly between the gearbox and differential of the prior art,

FIG. 3b is a schematic overview of the cross-section of the short cardan shaft sliding assembly between two axles of the prior art,

FIG. 4 is a schematic overview of the protector cover mounting diameter on a yoke shaft,

FIG. 5a is a detailed view of the protector cover mounting diameter on a yoke shaft in the prior art,

FIG. 5b is a detailed view of the protector cover mounting diameter on a yoke shaft,

### REFERENCE NUMBERS

10. Cardan shaft sliding assembly
11. Yoke shaft
12. Tube sleeve
13. Protective cover
14. Protective cover seal
15. Mounting diameter
16. Slip yoke
17. Oil cap
18. Plug
19. Seal housing diameter
20. Rear cardan shaft between gearbox and differential
30. Short cardan shaft between two axles
A. Gearbox-differential rear cardan shaft sliding assembly of the prior art
B. Short cardan shaft sliding assembly between two axles of the prior art

### DETAILED DESCRIPTION OF INVENTION

In this detailed description, the invention relates both to the gearbox-differential arrangement which gives the cardan shaft freedom of motion in the axial direction and consists of a yoke shaft (11), a tube sleeve (12), a protective cover (13), a protective cover seal (14) and a yoke shaft (11), a slip yoke (16), the cardan shaft sliding assembly (10) suitable for undercarriage arrangement between two axles, consisting of protective cover (13), protective cover seal (14), oil cap (17) and plug (18), is described only as an example for a better understanding of the subject and without any limiting effect.

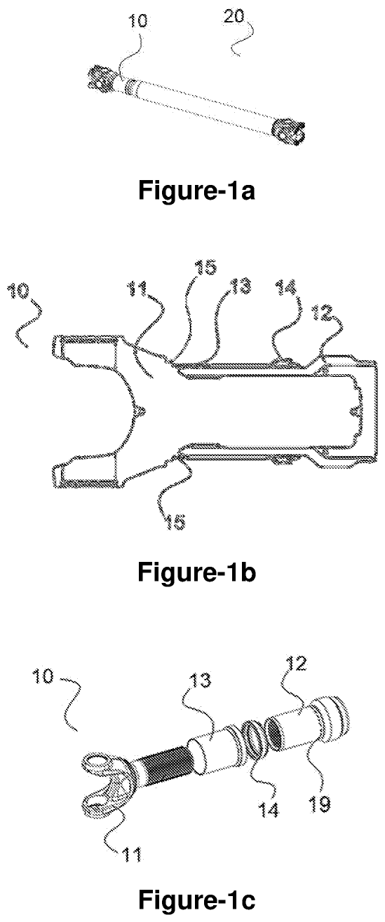

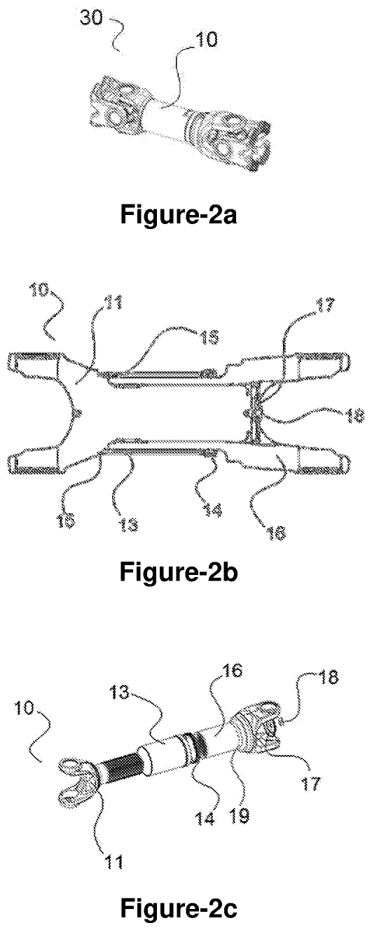

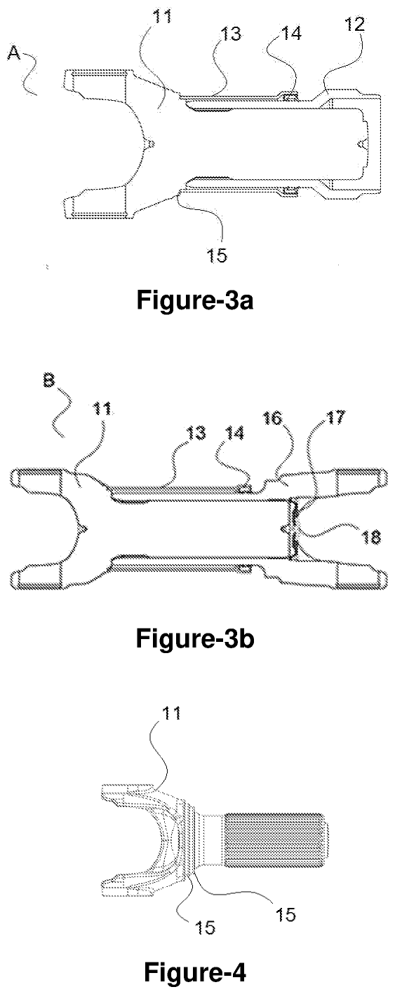

The cardan shaft sliding assembly (10) of the invention has different mounting diameters (15) on the yoke shaft (11) shown in FIG. 1b and FIG. 2b in order to enable the use of a single yoke shaft (11) for both the gearbox-differential arrangement shown in FIG. 1a and the undercarriage arrangement between two axles shown in FIG. 2a. In the prior art, the tube sleeve (12) used in the gearbox-differential rear cardan shaft sliding assembly (A) shown in FIG. 3a and the protective cover seal (14) on the slip yoke (16) used in the short cardan shaft sliding assembly between two axles (B) shown in FIG. 3-b have different mounting diameters (15). Due to the aforementioned diameter difference, the size of the protective cover (13) is also used differently and two different yoke shafts (11) with different product codes are machined due to the mounting diameter. Thanks to the presence of more than one mounting diameter (15) of different dimensions on a single yoke shaft (11) in the cardan shaft sliding assembly (10) of the invention, production and inventory costhave been reduced and product performance has been increased by reducing stress distribution.

The cardan shaft sliding assembly (10) arranged on the rear cardan shaft between gearbox and differential (20) shown in FIG. 1a and FIG. 1c comprises the yoke shaft (11), which provides freedom of motion in axial direction to the cardan shaft and is one of the parts forming the sliding assembly; tube sleeve (12), which is another part forming the sliding assembly and provides freedom of motion in axial direction to the cardan shaft; protective cover (13) protecting the tube sleeve (12) and yoke shaft (11) from external environmental effects; protective cover seal (14) which provides sealing during the axial movement of the tube sleeve (12) and the yoke shaft (11); and mounting diameter (15) arranged on the yoke shaft (11) to ensure the housing and assembly of the protective cover (13). The cardan shaft sliding assembly (10) with a short cardan shaft between two axles (30) shown in FIG. 2a and FIG. 2c comprises the yoke shaft (11), which provides the cardan shaft freedom of motion in the axial direction and is one of the parts forming the sliding assembly; slip yoke (16), which is one of the parts forming the sliding assembly and provides the cardan shaft freedom of movement in the axial direction; protective cover (13) that protects the slip yoke (16) and the yoke shaft (11) from external environment effects; protective cover seal (14), which ensures sealing during axial movement of the slip yoke (16) and yoke shaft (11); oil cap (17), which protects the slip yoke (16) and yoke shaft (11) from external environmental effects; the plug (18) through which the vacuum generated during the axial movement of the slip yoke (16) and the yoke shaft (11) is discharged by means of the holes in the oil cap (17); and the mounting diameter (15) arranged on the yoke shaft (11) to ensure the housing and assembly of the protective cover (13)

In the gearbox-differential arranged cardan shaft sliding assembly (10); protective cover seal (14) is attached to the mounting diameter (15) placed on the yoke shaft (11) and shown in FIG. 4, and the protective cover (13) is welded to the yoke shaft (11) after assembly. Next, the tube sleeve (12) is attached to the yoke shaft (11) with the help of threads and the assembly is completed. Cardan shaft sliding assembly (10) with a short cardan shaft between two axles (30) is welded to the yoke shaft (11) after the installation of the protective cover (13) with the protective cover seal (14) attached to the mounting diameter (15) placed on the yoke shaft (11) and shown in FIG. 4. Then, the slip yoke (16) with oil cap (17) and plug (18) attached with the help of threads is attached to the cardan shaft sliding assembly (11) and the assembly is completed.

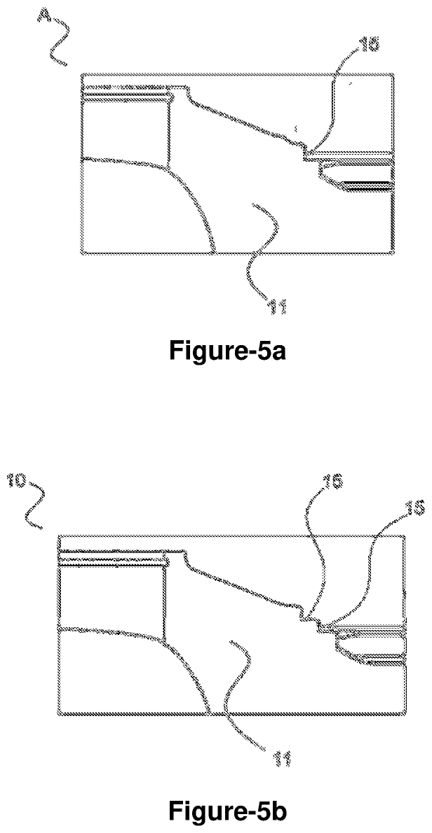

The diameters of the protective cover (13) used on the rear cardan shafts shown in FIG. 5a and the protective cover (13) used on the short cardan shaft sliding assembly between two axles differ from each other due to the difference in the seal housing diameters (19) of the tube sleeve (12) and the slip yoke (16), thus necessitating the use of a yoke shaft (11) with different yokes in both sliding assemblies. The mentioned seal housing diameter (19) is the outer diameter of the tube sleeve (12) and the slip yoke (16). Although the diameters of the protective cover (13) used in the rear cardan shafts of the invention shown in FIG. 5b and the protective cover (13) used in the short cardan shaft sliding assembly between two axles are different due to the seal housing diameters (19) of the tube sleeve (12) and the slip yoke (16), the common yoke shaft (11) can be used for both of them thanks to the mounting diameters (15) of different sizes.

1. A cardan shaft sliding assembly suitable for both a gearbox-differential arrangement, which gives the cardan shaft freedom of movement in an axial direction, and an undercarriage arrangement between two axles, the cardan shaft sliding assembly comprising;
a multiple number of mounting diameters of different dimensions positioned on a yoke shaft to ensure the assembly of a protective cover by housing both in the gearbox-differential arrangement and in the undercarriage arrangement between two axles;
wherein said yoke shaft with said mounting diameters provides the cardan shaft freedom of motion in the axial direction and is one of the parts forming the sliding assembly.

2. The cardan shaft sliding assembly according to claim 1, further comprising a tube sleeve, which is one of the parts forming the sliding assembly in the gearbox-differential arrangement and which provides the cardan shaft freedom of motion in the axial direction.

3. The cardan shaft sliding assembly (10) according to claim 1, wherein the protective cover protects the tube sleeve and the yoke shaft from external environmental effects in the gearbox-differential arrangement.

4. The cardan shaft sliding assembly according to claim 3, further comprising a protective cover seal used in the undercarriage arrangement between two axles which provides sealing during the axial movement of the tube sleeve and the yoke shaft.

5. The cardan shaft sliding assembly according to claim 1, further comprising a slip yoke which is one of the parts forming the sliding assembly and which provides the cardan shaft freedom of motion in the axial direction.

6. The cardan shaft sliding assembly according to claim 1, further comprising a slip yoke and a protective cover protecting the yoke shaft from external environmental effects.

7. The cardan shaft sliding assembly (10) according to claim 1, further comprising a slip yoke and a plug through which the vacuum generated during the axial movement of the yoke shaft is discharged by means of the oil cap holes.
